(19) United States
(12) Patent Application Publication
(10) Pub. No.: US 2017/0083294 A1
(43) Pub. Date: Mar. 23, 2017

(54) METHOD AND SYSTEM FOR PROGRAMMING MOVING ACTIONS OF A MOVING OBJECT WITH FUNCTIONAL OBJECTS

(71) Applicant: Zheng SHI, Beijing (CN)

(72) Inventors: Zheng Shi, Beijing (CN); Xingyi Gong, Beijing (CN); Yeliao Tao, Beijing (CN)

(21) Appl. No.: 15/119,387

(22) PCT Filed: May 8, 2015
(86) PCT No.: PCT/CN2015/078556

§ 371 Date: Aug. 16, 2016

(30) Foreign Application Priority Data
Jun. 13, 2014 (CN) PCT/CN2014/079891
Jul. 7, 2014 (CN) PCT/CN2014/081721
Aug. 15, 2014 (CN) PCT/CN2014/084498
Sep. 1, 2014 (CN) PCT/CN2014/085668
Sep. 17, 2014 (CN) PCT/CN2014/086745
Feb. 10, 2015 (CN) PCT/CN2015/072626

(51) Int. Cl. G06F 9/44

(52) U.S. Cl. CPC G06F 8/34; G06F 8/35; G06F 3/0488

(57) ABSTRACT

A system and method are provided for programming moving actions of a moving object with a plurality of functional objects in conjunction with an interactive surface that recognizes such objects and derives the structural pattern formed by the functional objects.

### TECHNICAL FIELD

The present invention relates to programming the moving actions of a moving object, and more specifically, an interactive surface that enables a user to use functional objects to create computer programs.

### BACKGROUND

“Everybody in this country should learn how to program a computer . . . because it teaches you how to think.”—Steve Jobs.

Computer programming is becoming a way of thinking and doing for the broader society, beyond the narrow confines of computer programming professionals, particularly as the Internet continues to be a transformative force in driving changes in almost every aspects of modern life. People are starting to learn computer programming at an ever-younger age, a trend encouraged and reinforced by programming tools and platforms specifically developed for younger children or beginners.

Currently there are a number of programming tools and platforms that enable the creation of interactive stories, games, and animations, and the sharing of such creations in the online community. Their stated aim is to help young people learn to think creatively, reason systematically, and work collaboratively. Many games running on smart phones or tablet computers have also been developed that aim to further reduce the entry barrier for programming, and to teach the ways of logical thinking, to children as young as 4 years of age, often without much focus on writing programming code.

However, despite all these efforts, learning to program a game is still not intuitive and less fun than playing one, and it is desirable to develop ways that make programming fun and intuitive. Currently, most if not all of the programming tools and games are screen-based—they require users to interact with an electronic screen, whether it is on a laptop computer, a smart phone, or a tablet computer. An off-screen and physical building blocks-based system and method would be desirable, especially for young children whose parents desire to stimulate the children's interest in structured thinking and logical reasoning but at the same time wish to reduce the children's time spent with electronic screens.

### SUMMARY OF THE INVENTION

The present invention discloses a novel way of programming the moving actions of a moving object using functional objects, in conjunction with an interactive surface.

In accordance with one embodiment of the present invention, a moving object is placed on an interactive surface, and the moving object further includes a movement module. A plurality of functional objects are also placed on the interactive surface. Each of the functional objects is marked with a programming symbol related to a moving action. The functional objects are placed next to each other or on top of each other to form a structural pattern. A processor that is operatively linked to the interactive surface is configured to derive a set of moving actions from the structural pattern, and direct the moving object to perform the moving actions on the interactive surface.

In accordance with one embodiment of the present invention, the moving object and each functional object further include an identifier, and the interactive surface is configured to recognize the identifier, location and orientation of the moving object and each functional object. The system further includes a memory that is configured to store a database of relationships among and between identifier, programming symbol and moving action.

In accordance with one embodiment of the present invention, the system further includes a wireless communication means, and the processor is configured to direct the moving object to perform the moving actions by sending the moving object moving instructions via the wireless means. And the processor is configured to track the movement of the moving object based on the identifier, location and orientation of the moving object periodically and throughout the movement of the moving object on the interactive surface.

In accordance with one embodiment of the present invention, the programming symbol represents a moving action to be performed by the moving object or a function for programming a moving action to be performed by the moving object.

In accordance with one embodiment of the present invention, the identifier may be encoded with a passive radio frequency identification chip, an active radio frequency identification chip, a pattern of capacitive tabs, or a pattern of magnetic tabs.

In accordance with one embodiment of the present invention, the sensory accessory can be an LED light, an audio device, a video device, or a vibration generator device. The processor is configured to direct a sensory accessory to produce an output related to the moving actions.

### BRIEF DESCRIPTION OF THE DRAWINGS

FIG. 1 is an exemplary schematic diagram illustrating the system process flow in accordance with one embodiment of the present invention.

FIGS. 2A and 2B are exemplary schematic diagrams illustrating the design of cards each assigned with a programming symbol in accordance with various embodiments of the present invention.

FIG. 3 is an exemplary schematic diagram of the system for programming the moving actions of a moving object using a physical sheet in accordance with one embodiment of the present invention.

FIG. 4 is an exemplary schematic diagram for a method for creating and running a computer program flow in accordance with one embodiment of the present invention.

### DETAILED DESCRIPTION OF THE INVENTION

Reference will now be made in detail to various embodiments of the invention, examples of which are illustrated in the accompanying drawings. While the invention will be described in conjunction with the embodiments, it will be understood that this is not intended to limit the scope of the invention to these specific embodiments. The invention is intended to cover all alternatives, modifications and equivalents within the spirit and scope of invention, which is defined by the apprehended claims.

Furthermore, in the detailed description of the present invention, specific details are set forth in order to provide a thorough understanding of the present invention. However, it will be obvious to one of ordinary skill in the art that the present invention may be practiced without these specific details. In other instances, well known methods, procedures, components, and circuits are not described in details to avoid unnecessarily obscuring a clear understanding of the present invention.

The present invention may be better understood and its numerous objects and advantages will become apparent to those skilled in the art by reference to the accompanying drawings.

The embodiments of the present invention disclose a system and method for creating and running a computer program for moving an object using functional objects, typically cards, in conjunction with the use of an interactive surface.

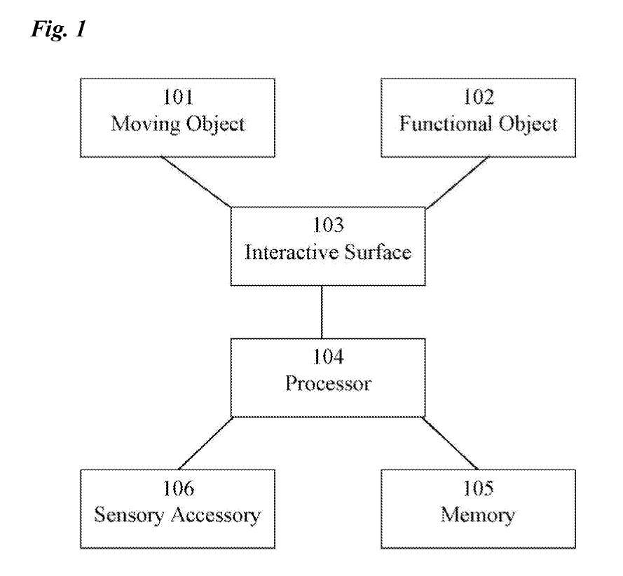

FIG. 1 is an exemplary schematic diagram illustrating the system process flow in accordance with one embodiment of the present invention. The system includes a moving object 101 and a plurality of functional objects 102. The moving object 101 further includes an identifier and a movement module. Each functional object 102 is embedded with an identifier, and marked with a programming symbol related to a moving action for the moving object 101 to perform. The identifier may be encoded with a passive radio frequency identification chip, an active radio frequency identification chip, a pattern of capacitive tabs, or a pattern of magnetic tabs. The functional object 102 can be a card, a button, a block, an icon, a sheet, or a figurine. Each programming symbol can take various forms and patterns and serve different functions. In this embodiment of the present invention, it represents either moving actions or programming functions.

The system further includes an interactive surface 103, a processor 104 that is operatively linked to the interactive surface, a memory 105, and a wireless communication means. The interactive surface 103 recognizes the identifier, location and orientation of the moving object 101 and the functional objects 102 placed on or near the interactive surface 103 in real time. The memory 105 is operatively linked to the processor 104 and stores a database of relationships among and between identifiers, programming symbols and moving actions. The processor 104 derives a set of moving actions based on the programming symbols embedded in the structural pattern formed by the functional objects 102 placed on the interactive surface 103 and directs the moving object 101 to perform the set of moving actions by sending the moving object 101 moving instructions via the wireless means.

The system described in FIG. 1 further includes a sensory accessory 106 that can be an LED light, an audio device, a video device, or a vibration generator device. The processor 104 directs the sensory accessory 106 to produce an output related to the moving actions of the moving object 101.

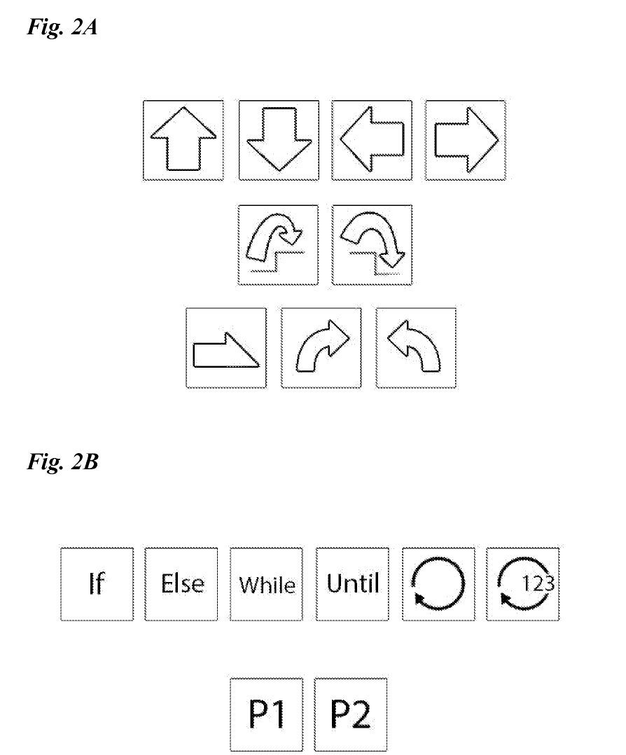

FIGS. 2A and 2B are exemplary schematic diagrams illustrating the design of cards each assigned with a programming symbol in accordance with various embodiments of the present invention.

1. Moving Action Cards

Several moving action cards are used to represent moving actions performed by the moving object in different directions. As shown in FIG. 2A, the moving object could move up, down, left or right, could jump up or down, could keep moving forward, and could turn left or right.

2. Programming Function Cards

The moving action to be performed by the moving object is programmed using a few programming function cards. As shown in FIG. 2B, the examples include “If”, “Else”, “While”, “Until”, and “Loop” (and the number of “Loop”). The programming function cards also include cards representing subroutine functions, which are symbolized “P1”, “P2”. In computer programming, a subroutine is a sequence of program instructions that perform a specific task, packaged as a unit, depending on the programmer's definitions. This unit can then be used in programs wherever that particular task should be performed, which reduces a lot of workload of coding.

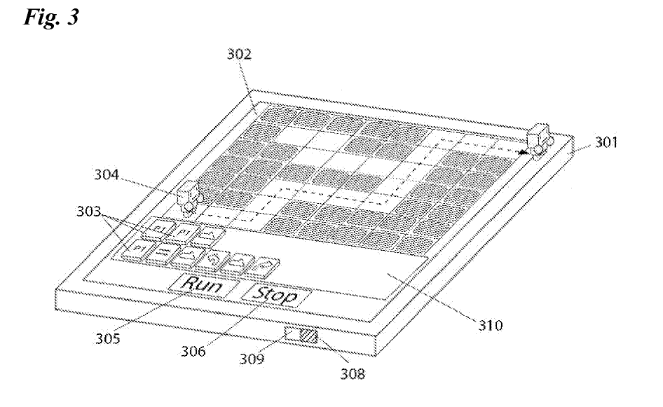

FIG. 3 is an exemplary schematic diagram of the system for programming the moving actions of a moving object using a physical sheet in accordance with one embodiment of the present invention. As shown in FIG. 3, the system includes a physical sheet 302 with printed elements to lay out a maze placed on the interactive surface 301, and a set of cards 303, each visually marked with a programming symbol, placed on the coding area 310 of the physical sheet 302. Each card 303 is related to a moving action for a moving object 304 to perform. The moving object 304 further includes an identifier and a movement module. In this particular embodiment, a set of moving actions are programmed to direct the moving object 304 trapped in a maze out of the maze, based on the programming symbols embedded in the structural pattern formed by the cards 303 placed on the coding area of the physical sheet 302.

As shown in FIG. 3, two categories of cards 303 printed with programming symbols are placed on the interactive surface 301 to program the moving actions of the moving object 304. Specifically, moving action cards are used to represent movement of the moving object 304 in different directions, and the programming function card “P1”, which is defined as a specific sequence of cards, is used to call a subroutine to reduce the number of cards used. Two function buttons, namely the run button 305 and the stop button 306, are located at the bottom of the physical sheet 302 for the user to interact with.

The physical sheet 302 with printed elements to lay out a maze is first placed on top of the interactive surface 301, and then the moving object 304 is placed on the physical sheet 302. The interactive surface 301 detects the ID, location and orientation of the moving object 304 and transmits such information to the processor 308 that is operatively linked to the interactive surface 301. The physical sheet also includes an identifier that can be detected and recognized by the interactive surface 301.

Multiple cards 303 are then placed next to each other to form a structural pattern in the coding area 310 of the physical sheet 302. The interactive surface 301 detects the ID, location and orientation of the cards 303 placed on the interactive surface 301, and transmits such information to the processor 308. The processor 308 receives the information and derives a set of moving actions for the moving object to perform, based on the programming symbols embedded in the structural pattern formed by the cards 303 and a database of relationships among and between identifiers, programming symbols and moving actions stored in the memory 309. The processor 308 then directs the moving object 304 to perform the set of moving actions derived above by sending the moving object moving instructions via a wireless means (not shown). The processor 308 also tracks the movement of the moving object 304 based on the identifier, location and orientation of the moving object periodically and throughout the movement of the moving object on the interactive surface 301.

The user can run the computer program that has been created by pressing the play button 305, and the output is produced via a sensory accessory (not shown), which can be arranged to produce an output to indicate the progress of execution of the set of moving actions. For example, an LED light may be attached to each card 303, and the LED light can be lighted when the moving action associated with that particular card 303 is being executed, which enables the user to visualize the execution of the moving actions by the moving object 304, and easily track any movement of the moving object 304 that does not execute as intended. The sensory accessory can also be an audio device, a video device, or a vibration generator device. If the user is unsatisfied with the actions derived or would like to debug, he may simply press the stop button 306 first, and then add, remove, or change cards to re-derive a set of moving actions.

As illustrated in FIG. 3, the execution of the moving actions directs the moving object 304 trapped in a maze out of the maze. The sequence of the cards used in this embodiment for programming the moving actions is as follows, “Procedure 1”, “Procedure 1”, and “move forward”. The sequence of the cards that defines the subroutine P1 is as follows, “move forward”, “turn left”, “move forward”, “turn right”. The complete set of moving actions derived from the programming symbols embedded in the structural pattern formed by the cards 303 are as follows: “move forward”, “turn left”, “move forward”, “turn right”, “move forward”, “turn left”, “move forward”, “turn right”, “move forward”.

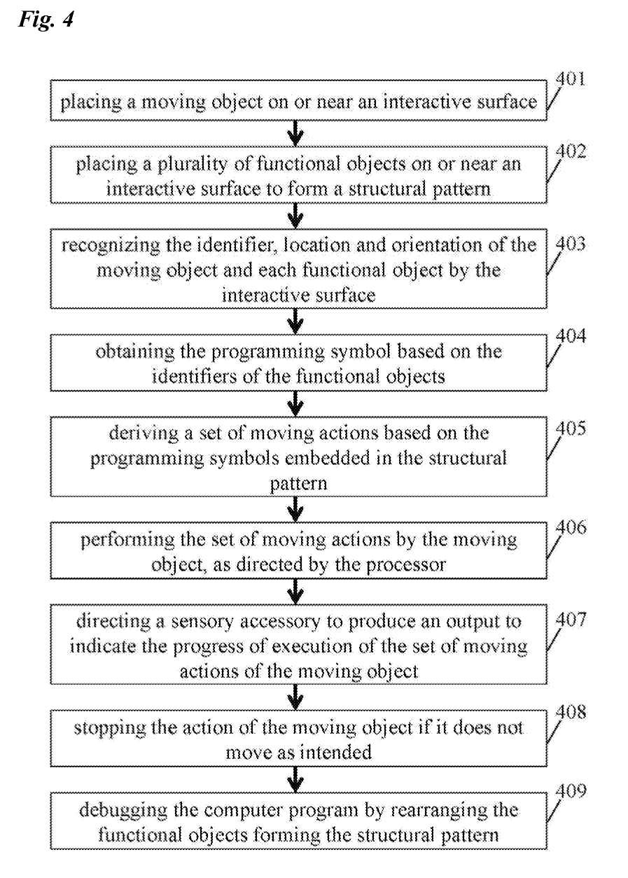

FIG. 4 is an exemplary schematic diagram for a method for creating and running a computer program flow in accordance with one embodiment of the present invention. As shown in FIG. 4, the method includes the following steps.

Step 401: placing a moving object on or near an interactive surface. The moving object consists of an identifier and a movement module.

Step 402: placing a plurality of functional objects on or near an interactive surface to form a structural pattern. Each object includes an identifier and is marked with a programming symbol related to a moving action for the moving object to perform.

Step 403: recognizing the identifier, location and orientation of the moving object and each functional object by the interactive surface. The interactive surface detects the identifier, location and orientation of the moving object and each functional object placed on or near the interactive surface.

Step 404: obtaining the programming symbol based on the identifiers of the functional objects. A database of correlation relationships between identifiers and programming symbols is stored in a memory, and the processor obtains a programming symbol for each functional object.

Step 405: deriving a set of moving actions based on the programming symbols embedded in the structural pattern. A database of correlation relationship between programming symbols and moving actions is also stored in the memory. The processor derives a set of moving actions based on the location and orientation of the moving object and the programming symbols embedded in the structural pattern formed by the functional objects.

Step 406: performing the set of moving actions by the moving object, as directed by the processor. For example, the user can push a Play button to initiate the moving actions by the moving object, as shown in FIG. 3.

Step 407: directing a sensory accessory to produce an output to indicate the progress of execution of the set of moving actions of the moving object. The system may include a sensory accessory, such as LED lights. For example, an LED light may be attached to each functional object, and the LED light can be lighted when the moving action represented by a particular functional object is being executed, which enables the user to visualize the progress of execution of the set of moving actions of the moving object.

Step 408: stopping the action of the moving object if it does not move as intended. For example, if the moving object in FIG. 3 does not move in the intended path, the user can stop its action by pushing a stop button.

Step 409: debugging the computer program by rearranging the functional objects forming the structural pattern. The user can easily debug the computer program as the LED light will direct him to the functional object that is causing the problem.

1. A system for programming moving actions, comprising:
a moving object comprising a movement module;
a plurality of functional objects, each marked with a programming symbol related to a moving action;
an interactive surface; and
a processor operatively linked to the interactive surface;
wherein, the interactive surface recognizes the location and orientation of the moving object and the functional objects placed thereon in real time, and the processor derives a set of moving actions based on the programming symbols embedded in a structural pattern formed by the functional objects placed on the interactive surface, and directs the moving object to perform the set of moving actions based on the location and orientation of the moving object on the interactive surface.

2. The system of claim 1, wherein the moving object and the functional object further comprise an identifier, and the interactive surface is configured to recognize the identifier.

3. The system of claim 2, wherein the identifier is encoded with a means selected from a group consisting of a passive radio frequency identification chip, an active radio frequency identification chip, a pattern of capacitive tabs, and a pattern of magnetic tabs.

4. The system of claim 2, wherein the processor is configured to track the movement of the moving object based on the identifier, location and orientation of the moving object periodically and throughout the movement of the moving object on the interactive surface.

5. The system of claim 1, further comprising a wireless communication means, wherein the processor is configured to direct the moving object to perform the moving actions by sending the moving object moving instructions via the wireless means.

6. The system of claim 1, wherein the programming symbol represents a moving action to be performed by the moving object or a programming function for programming a moving action to be performed by the moving object.

7. The system of claim 1, further comprising a memory that is configured to store a database of relationships among and between identifiers, programming symbols and moving actions.

8. The system of claim 1, further comprising of a sensory accessory selected from a group consisting of an LED light, an audio device, a video device, and a vibration generator device, wherein the processor is configured to direct the sensory accessory to produce an output related to the moving actions.

9. A method for programming moving actions, comprising:
recognizing, by an interactive surface, the location and orientation of a moving object and a plurality of functional objects placed thereon in real time, wherein the moving object further comprises a movement module, and each functional object is marked with a programming symbol related to a moving action;
deriving, by a processor, a set of moving actions based on the programming symbols embedded in a structural pattern formed by the functional objects placed on the interactive surface;
directing, by the processor, the moving object to perform the set of moving actions based on the location and orientation of the moving object on the interactive surface.

10. The method of claim 9, wherein the moving object and the functional object further comprise an identifier, and the method further comprising recognizing the identifier of the moving object or the functional object by the interactive surface.

11. The method of claim 10, wherein the identifier is encoded with a means selected from a group consisting of a passive radio frequency identification chip, an active radio frequency identification chip, a pattern of capacitive tabs, and a pattern of magnetic tabs.

12. The method of claim 10, further comprising, tracking the movement of the moving object by the processor based on the identifier, location and orientation of the moving object periodically and throughout the movement of the moving object on the interactive surface.

13. The method of claim 9, further comprising a wireless communication means, and the method further comprising directing the moving object to perform the moving actions by sending the moving object moving instructions via the wireless means by the processor.

14. The method of claim 9, wherein the programming symbol represents a moving action to be performed by the moving object or a programming function for programming a moving action to be performed by the moving object.

15. The method of claim 9, further comprising a memory that is configured to store a database of relationships among and between identifiers, programming symbols and moving actions.

16. The method of claim 9, further comprising of a sensory accessory selected from a group consisting of an LED light, an audio device, a video device, and a vibration generator device, and the method further comprising directing a sensory accessory to produce an output related to the moving actions by the processor.
